(19) United States
(12) Patent Application Publication
(10) Pub. No.: US 2004/0054036 A1
(43) Pub. Date: Mar. 18, 2004

(54) High functional polymers

(76) Inventors: Kevin Brian Hatton, Harlow (GB); Zhi Xin Li, Oxford (GB)

Correspondence Address: PROSKAUER ROSE LLP, PATENT DEPARTMENT, 1585 BROADWAY, NEW YORK, NY, 10036-8299, US

(21) Appl. No.: 10/416,101

(22) PCT Filed: Aug. 23, 2001
(86) PCT No.: PCT/EP01/09757

(30) Foreign Application Priority Data
Oct. 26, 2000 (EP) 00810991.0

(51) Int. Cl. C08L 63/00

(52) U.S. Cl. 523/400

(57) ABSTRACT

Compounds of formula (I) wherein Q denotes a n-valent residue of an aliphatic polyol having a weight average molecular weight mw of 100 to 25000, n is an integer from 2 to 512, R1 is hydrogen or methyl, A denotes a m-valent aliphatic, cycloaliphatic, aromatic or araliphatic radical, m is an integer from 2 to 4, and Y is a radical of formula (II) or (III) wherein E is a k-valent aliphatic, cycloaliphatic, aromatic or araliphatic radical and k is an integer from 2 to 4, can be used as curing agents for epoxy resins and yields products of high fracture and impact toughness.

The present invention relates to high functional polymers containing at least two terminal amino or carboxyl groups, a process for the preparation of these compounds, curable compositions containing these compounds and the use of the curable compositions.

Densely packed, highly functionalised compounds are of considerable interest for applications in high performance plastics. Attributes of high fracture and impact toughness, high elongation and flexural strength as well as water/chemical resistance are being sought.

U.S. Pat. No. 5,508,324 discloses polyamine epoxy adducts which are useful as epoxy resin curing agents in two component waterborne coating systems.

Because of their tendency to gellation the preparation of high functional polymers derived from polyepoxides in general is not easy.

In the International Application No. PCT/EP 00/05170 a process of reacting multifunctional hydroxy compounds with bis-cycloaliphatic epoxides to produce reaction products containing cycloaliphatic epoxides useful in curable compositions is described. Particular heterogenous catalysts are required to promote the reaction. After reaction the catalyst is removed by filtration.

It has now been found that high functional polymers containing hydroxy groups and terminal amino or carboxyl groups having a low viscosity can be prepared by reaction of monomeric or polymeric compounds having at least two hydroxy groups with an excess of polyepoxides and subsequent reaction of the thus obtained intermediate with a polyamine or a polycarboxylic acid.

In the present invention, it has been found particularly that in the first process step an in situ soluble catalyst can be used affording the capability to control, by suitable base inactivation, the amount of reaction promoted.

Further, the destroyed catalyst and any minor residual deactivator compound does not inhibit the use of the reaction products in subsequent curable compositions.

Thus the procedure described herein simplifies over the earlier method in that there is no need for filtration. Furthermore there is greater reaction control.

Accordingly, the present invention relates to a compound of the formula I

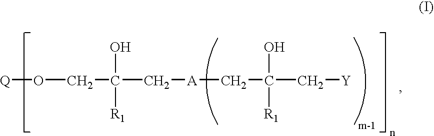

wherein Q denotes a n-valent residue of an aliphatic polyol having a weight average molecular weight m_{w} of 100 to 25000, n is an integer from 2 to 512,

R₁ is hydrogen or methyl,

A denotes a m-valent aliphatic, cycloaliphatic, aromatic or araliphatic radical, m is an integer from 2 to 4, and Y is a radical of formula II or III

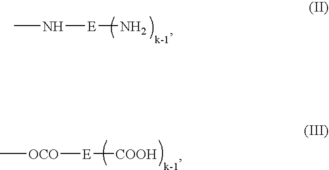

wherein E is a k-valent aliphatic, cycloaliphatic, aromatic or araliphatic radical and k is an integer from 2 to 4.

The radical Q is derived from multifunctional alcohols or multifunctional carboxylic acids. Preferred polyols are polyalkylene glycols, like polyethylene glycol, polypropylene glycol and polytetrahydrofurane, trimethylolpropane, ethoxylated trimethylolpropane, propoxylated trimethylolpropane, pentaerythritol, ethoxylated pentaerythritol, propoxylated pentaerythritol, polyglycols obtainable by reaction of pentaerythritol with ethylene oxide, propylene oxide, tetrahydrofuran or ε-caprolactone, dipentaerythritol, ethoxylated dipentaerythritol, propoxylated dipentaerythritol, polyglycols obtainable by reaction of dipentaerythritol with ethylene oxide, propylene oxide, tetrahydrofuran or ε-caprolactone, hydroxyl- or carboxyl-terminated dendritic macromolecules containing a nucleus derived from a monomeric or polymeric compound having at least one reactive hydroxyl, carboxyl or epoxy group per molecule and at least one branching generation derived from a monomeric or polymeric chain extender having at least three reactive sites per molecule selected from hydroxyl and carboxyl groups.

Dendritic macromolecules are well-known, for example from U.S. Pat. Nos. 5,418,301 and 5,663,247, and partly commercially available (e.g. Boltorn® supplied by Perstorp).

Hyperbranched and dendritc macromolecules (dendrimers) can generally be described as three dimensional highly branched molecules having a tree-like structure. Dendrimers are highly symmetric, while similar macromolecules designated as hyperbranched may to a certain degree hold an asymmetry, yet maintaining the highly branched tree-like structure. Dendrimers can be said to be monodisperse variations of hyperbranched macromolecules. Hyperbranched and dendritic macromolecules normally consist of an initiator or nucleus having one or more reactive sites and a number of surrounding branching layers and optionally a layer of chain terminating molecules. The layers are usually called generations, a designation hereinafter used.

In a preferred embodiment, the compounds of the formula I are derived from a polyethylene glycol, a polypropylene glycol, a polytetrahydrofurane or from a hydroxyl-terminated dendritc macromolecule containing 8 to 256 hydroxyl groups per molecule and having a weight average molecular weight m_{w} from 500 to 25000.

Moreover, compounds of formula I are preferred wherein R₁ is hydrogen, m is 2 and A is a bivalent radical of the formula IVa to IVd

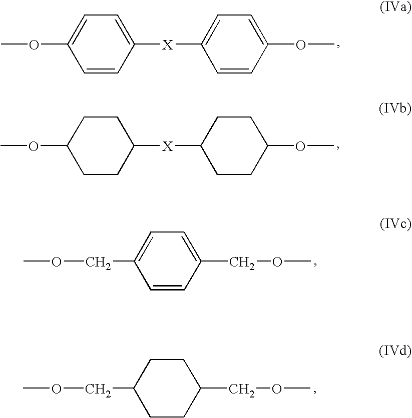

wherein X is a direct bond, methylene, isopropylidene, —CO— or —SO₂—.

Further preferred compounds of formula I are those wherein R₁ is hydrogen, m is 3 or 4 and A is a trivalent radical of the formula Va or a tetravalent radical of formula Vb

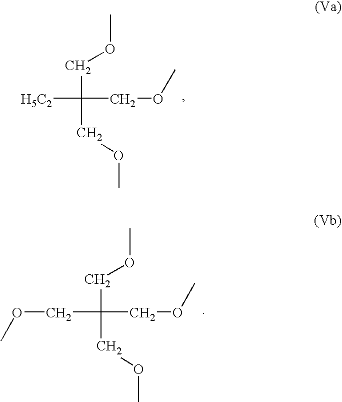

Further preferred compounds of formula I are those wherein Y is a radical of formula II wherein E denotes a bivalent, trivalent or tetravalent aliphatic radical containing up to 100 carbon atoms in which one or more carbon atoms may be replaced by oxygen or nitrogen atoms.

In particular, Y is a radical of formula II wherein E denotes a radical of formula VIa to VIg

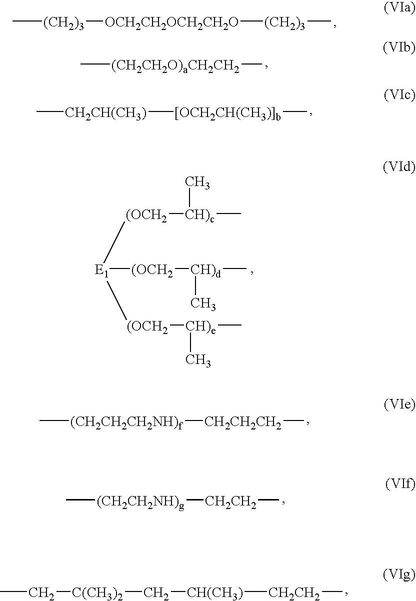

wherein a and b are an integer from 1 to 10, c, d and e independently of one another are an integer from 1 to 20, f is an integer from 1 to 5, g is an integer from 1 to 10 and E₁ is a radical of formula VIIa or VIIb

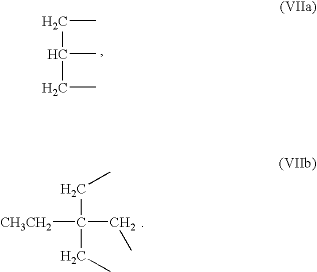

Furthermore, compounds of formula I are preferred wherein Y is a radical of formula III wherein E is the bivalent residue, after removal of the carboxyl groups, of an aliphatic dicarboxylic acid containing 4 to 20 carbon atoms or of a dimer fatty acid.

The reaction of difunctional alcohols with difunctional epoxy compounds using metal triflate catalysts and basic deactivators is described in EP-A 493 916.

Surprisingly we have found that the same synthetic methods can be extended to react multifunctional (>2) alcohols with di- or multifunctional epoxides to give higher molecular weight epoxy resins which then can further be reacted with polyamines or polycarboxylic acids to yield high functional polymers of formula I.

There is reported work in the art seeking to achieve highly functional epoxy dendrimeric compounds; these have not been successful.

The present invention has achieved high functionalisation by both a combination of careful control of the reaction conditions and ensuring that the ratio of the starting epoxide to the starting hydroxyl compound is high enough so that gellation does not occur.

Accordingly, the present invention also relates to a process for the preparation of a compound of formula I according to claim 1 which comprises reacting a compound Q—(OH)ₙ wherein Q and n are as defined in claim 1 with a compound of formula VIII

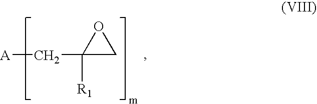

wherein A, R₁ and m are as defined in claim 1, in such amounts that 1.5 to 15.0 epoxy equivalents are present per hydroxy equivalent in the presence of a triflate salt of a metal of Group IIA, IIB, IIIA, IIIB or VIIIA of the Periodic Table of the Elements (according to the IUPAC 1970 convention), optionally deactivating the triflate salt catalyst when the desired amount of modification has been achieved, and subsequently reacting the epoxy group containing intermediate thus obtained with a polyamine of the formula E—(NH₂)ₖ or a polycarboxylic acid of the formula E—(COOH)ₖ wherein E and k are as defined in claim 1 in such amounts that at least two NH₂ groups or COOH groups are present per epoxy group of the intermediate.

Suitable hydroxy compounds Q—(OH)ₙ are basically all monomeric, oligomeric or polymeric compounds containing at least two hydroxy groups per molecule. Examples are diethylene glycol, dipropylene glycol, polytetrahydrfurane, trimethylolpropane, pentaerythritol, bistrimethylolpropane, diglycerol, dipentaerythritol, 3,3,5,5-tetramethylol-4-hydroxypyran, sugar alcohols, polymers having a molecular weight of at most 8000 obtained by reaction of ethylene oxide, propylene oxide, tetrahydrofuran or ε-caprolactone and one or more of the aforementioned hydroxy compounds.

Hydroxy-terminated dendritic macromolecules are further suitable compounds Q—(OH)ₙ. Dendritic macromolecule can be obtained by reaction of

(A) a central monomeric or polymeric nucleus having at least one reactive hydroxyl, carboxyl or epoxy group per molecule,

(B) at least one branching monomeric or polymeric chain extender having at least three reactive sites per molecule selected from hydroxyl and carboxyl groups, optionally

(C) at least one spacing monomeric or polymeric chain extender having two reactive sites per molecule selected from hydroxyl and carboxyl groups.

Such dendritic macromolecules are described, for example, in U.S. Pat. Nos. 5,418,301 and 5,663,247.

Specific examples of preferred aliphatic multihydroxy compounds Q—(OH)ₙ.(where n>4) include a range of dendritic polyols produced by Perstorp Polyols and sold under the Trade Name Boltorn® Dendritic Polymers. These include Boltorn® H20 (OH functionality=16 and molecular weight=1800) and Boltorn® H30 (OH functionality=32 and molecular weight=3600), Boltorn® H40 (OH functionality=64 and molecular weight=7200) and Boltorn® H50 (OH functionality=128 and molecular weight=14400), as well as such alcohols substituted by alkoxy groups as well as higher polyoxyethylene glycols, poloxypropylene glycols, polyoxytetramethylene glycols and polycaprolactone based on such alcohols.

Suitable epoxy compounds of formula VIII are glycidyl esters, glycidyl ethers, N-glycidyl compounds, S-glycidyl compounds as well as the corresponding β-methylglycidyl compounds.

As examples of such resins may be mentioned glycidyl esters obtained by reaction of a compound containing two or more carboxytic acid groups per molecule, with epichlorohydrin or glycerol dichlorohydrin in the presence of an alkali hydroxide.

Such diglycidyl esters may be derived from aliphatic dicarboxylic acids, e.g. succinic acid, glutaric acid, adipic acid, pimelic acid, suberic acid, azelaic acid and dimerised linoleic acid; from cycloaliphatic dicarboxylic acids such as tetrahydrophthalic acid, 4-methyltetrahydrophthalic acid, hexahydrophthalic acid and 4-methylhexahydrophthalic acid; and from aromatic dicarboxylic acids such as phthalic acid, isophthalic acid and terephthalic acid.

Such triglycidyl esters may be obtained from aliphatic tricarboxylic acids, e.g. aconitic acid and citric acid, from cycloaliphatic tricarboxylic acids such as 1,3,5-cyclohexanetricarboxylic acid and 1,3,5-trimethyl-1,3,5-cyclohexanetricarboxylic acid; and from aromatic tricarboxylic acids such as 1,2,3 benzene tricarboxylic acid, 1,2,4 benzene tricarboxylic acid and 1,3,5 benzene tricarboxylic acid.

Further examples are glycidyl ethers obtained by reaction of a compound containing at least two free alcoholic hydroxy and/or phenolic hydroxyl groups per molecule with epichlorohydrin or glycerol dichlorohydrin under alkaline conditions or, alternatively, in the presence of an acid catalyst and subsequent treatment with alkali. These ethers may be made from acyclic alcohols such as ethylene glycol, diethylene glycol and higher poly(oxyethylene) glycols, propane-1,2-diol and poly(oxypropylene) glycols, propane-1,3-diol, butane-1,4-diol, poly(oxytetramethylene)glycols, pentane-1,5-diol, hexane-2,4,6triol, glycerol, 1,1,1-trimethylolpropane, pentaerythritol, and sorbitol; from cycloaliphatic alcohols such as resorcitol, quinitol, bis(4-hydroxycyclohexyl) methane, 2,2-bis(4-hydroxycyclohexyl) propane, 1,1-bis(hydroxymethyl)-cyclohex-3-ene, 1,4-cyclohexane dimethanol, and 4,9-bis(hydroxymethyl)tricyclo[5,2,1,0^{2,6}] decane; and from alcohols made from aromatic nuclei, such as N,N-bis(2-hydroxyethyl)aniline and p,p¹-bis(2-hydroxyethylamino)diphenylmethane. Or may be made from mononuclear phenols such as resorcinol and hydroquinone, and from polynuclear phenols such as bis(4-hydroxyphenyl)methane, 4,4′-dihydroxyphenyl sulfone, 1,1,2,2-tetrakis(4-hydroxyphenyl)methane, 2,2-bis (4-hydroxyphenyl)propane, 2,2-bis(3,5dibromo-4-hydroxyphenyl)propane (tetrabromobisphenol A), and novolaks formed from aldehydes such as formaldehyde, acetaldehyde, chloral and furfuraldehyde, with phenols such as phenol itself, and phenol substituted in the ring by chlorine atoms or by alkyl groups each containing up to nine carbon atoms, such as 4-chlorophenol, 2-methyl phenol and 4-tert-butylphenol.

Di(N-glycidyl) compounds include, for example, those obtained by dehydrochlorination of the reaction products of epichlorohydrin with amines containing at least two amino hydrogen atoms such as aniline, n-butyl amine, bis(4-aminophenyl)methane and bis(4-methylaminophenyl)methane; and N,N′-digylcidyl derivatives of cyclic ureas, such as ethylurea and 1,3-propyleneurea, and hydantoins such as 5,5-dimethylhydantoin.

Examples of di(S-glycidyl) compounds are di-S-glycidyl derivatives of thiols such as ethane-1,2-dithiol and bis(4-mercaptomethylphenyl) ether.

Preferred compounds of formula VIII are diglycidylethers of bisphenols, cyclohexanedimethanol diglycidylether, trimethylolpropane triglycidylether and pentaerythritol tetraglycidylether.

Bisphenol A diglycidylether and trimethylolpropane triglycidylether are particularly preferred.

The triflate salts disclosed in EP-A 493 916 can also be used as catalyst in the first step of the process for the preparation of the compounds of formula I according to the present invention.

Preferably, the Group IIA metal triflate catalyst is magnesium triflate; the Group IIB metal triflate is preferably zinc or cadmium triflate; the Group IIIA metal triflate catalyst is preferably lanthanum triflate; the Group IIIB metal triflate is preferably aluminium triflate; and the Group VIIIA triflate catalyst is preferably cobalt triflate.

The amount of the metal triflate catalyst used in the process of the invention ranges from 10 to 500 ppm, especially from 50 to 300 ppm, based on the total weight of the reaction mixture.

The avoidance of gellation requires to employ the starting epoxide and the starting hydroxyl compound in such amounts that a substantial excess of epoxy groups is present. This ratio depends on the starting functionalities of both the hydroxy and epoxy groups present but usually falls in the region of hydroxy:epoxy of between 1:1.5 and 1:10, especially between 1:2 and 1:5.

In general it is convenient to employ the metal triflate catalyst in the form of a solution in an organic solvent. Examples of suitable solvents include aromatic hydrocarbon solvents; cycloaliphatic polar solvents such as cycloaliphatic ketones, e.g. cyclohexanone; polar aliphatic solvents such as diols, e.g. diethylene glycol, triethylene glycol, dipropylene glycol, tripropylene glycols as well as using the starting polyol where appropriate.

During the course of the reaction the amount of modification (10-100%) can be followed by measuring the epoxide content of the reaction mixture and the triflate catalyst may be deactivated once the desired amount of modification has been achieved.

As the process of modification proceeds secondary alcohol is generated. Depending on the amount of modification required, especially approaching 100%, the secondary alcohol groups can play a significant part in the reaction process and in some cases the epoxide content can be such that >100% modification can occur. In order to ensure that this process does not continue and lead to gellation (or high viscosity products) the amount of modification should aim not to exceed a maximum of 150% based on the starting alcohol.

Preferably, the triflate salt catalyst is deactivated when 10-100% of the initial hydroxyl groups of the compound Q—(OH)ₙ has been epoxidised.

The triflate salt catalyst deactivation may be effected e.g. by addition of alkali metal hydroxides or tetraalkylammonium hydroxide salts. Alternatively, the metal triflate salt catalyst used in the process of the present invention can be deactivated by adding a metal complexing agent, e.g. 8-hydroxyquinoline.

The second step of the process, i.e. the addition of a polyamine or a polycarboxylic acid to the epoxy group containing intermediate, is appropriately carried out at elevated temperature, preferably at 50 to 100° C. Since this reaction is strongly exothermic, the epoxy resin is preferably added to the amine or carboxylic acid in batches in order to achieve that the reaction temperature does not exceed 90° C. After complete addition of the epoxy resin the reaction mixture may be heated to 90 to 100° C.

Preferably 1 to 5 mol polyamine of the formula E—(NH₂)ₖ or polycarboxylic acid of the formula E—(COOH)ₖ is employed per mol epoxy groups of the intermediate obtained by reaction of Q—(OH)ₙ with a compound of formula VIII.

The present invention further relates to a curable composition containing

(a) an epoxy resin and

(b) a compound of formula I as described above.

Suitable epoxy resins (a) are the above-mentioned compounds of formula VIII. Moreover, epoxy resins may be used in which the 1,2-epoxide groups are bonded to different hetero atoms and/or functional groups; those compounds include, for example, the N,N,O-triglycidyl derivative of 4aminophenol, the glycidylether-glycidylester of salicylic acid, N-glycidyl-N′-(2-glycidyloxypropyl)-5,5-dimethylhydantoin and 2-glycidyloxy-1,3-bis-(5,5-dimethyl-1-glycidylhydantoin-3-yl)propane.

The crosslinked products obtained by curing a composition containing an epoxy resin and a compound of formula I exhibit excellent properties with respect to fracture and impact toughness, elongation and flexural strength as well as water/chemical resistance and are a further object of the invention.

The compositions according to the invention are excellently suitable as casting resins, laminating resins, adhesives, compression moulding compounds, coating compounds and encapsulating systems for electrical and electronic components, especially as casting resins and adhesives.

The following examples are illustrative of the present invention and are therefore not intended as a limitation on the scope thereof.

### EXAMPLES

Preparation of Epoxide E-1

A three-neck flask is fitted with a mechanical stirrer, a thermometer and a vacuum line. Stirring is kept through the whole reaction. A mixture of bisphenol A diglycidylether having an epoxide content of 5.3 val/kg (70.1 g) and polytetrahydrofurane 650 (29.5 g) is heated at 80° C. under vacuum for 30 min. A 5% solution of lanthanum(III)triflate in polytetrahydrofurane 650 (0.4 g) is added and the reaction is heated 3 h at 130° C. by which time the epoxide content has fallen to 3.0 mol/kg. A 2% solution of tetramethylammonium hydroxide in tripropylene glycol (0.4 g) is added and the reaction is allowed to cool to room temperature under vacuum with agitation.

Preparation of Epoxide E-2

A three-neck flask is fitted with a mechanical stirrer, a thermometer and a vacuum line. Stirring is kept through the whole reaction. A mixture of 133 g trimethylolpropane triglycidylether having an epoxide content of 8.2 val/kg and polytetrahydrofurane (Polymeg 1000) is dried 0.5 h at 110° C. under vacuum. 2.0 ml 5% lanthanum(III) triflate in tripropylene glycol is added and the mixture is heated at 145° C. under vacuum for approximately 6-8 hours until the epoxide content has fallen to 2.2-2.4 mol/kg. 2.0 ml of tetramethylammonium hydroxide in tripropylene glycol is added as de-activator of the catalyst after the mixture has cooled to 100° C. The temperature is kept at 80° C. for a further half hour.

Preparation of Epoxide E-3

A three-neck flask is fitted with a mechanical stirrer, a thermometer and a vacuum line. Stirring is kept through the whole reaction. A mixture of 98 g trimethylolpropane triglycidylether having an epoxide content of 8.2 val/kg and 270 g polypropylene glycol (Desmophen C200) is dried at 110° C. for half an hour under vacuum. 2.0 ml 5% lanthanum(III) triflate in tripropylene glycol is added and the mixture is heated at 145° C. under vacuum for approximately 6-8 hours until the epoxide content has fallen to 1.5-1.6 mol/kg. 2.0 ml of tetramethylammonium hydroxide in tripropylene glycol is added as de-activator of the catalyst after the mixture has cooled to 100° C. The temperature is kept at 80° C. for a further half hour.

Preparation of Epoxide E-4

A three-neck flask is fitted with a mechanical stirrer, a thermometer and a vacuum line. Stirring is kept through the whole reaction. A mixture of 107 g trimethylolpropane triglycidylether having an epoxide content of 8.2 val/kg and 40 g Boltorn® H30 (a dendritic polyester polyol with theoretically 32 primary hydroxyl groups per molecule and a molecular weight of approximately 3600 g/mol supplied by Perstorp) is dried at 110° C. under vacuum for half an hour. 1.2 ml 5% lanthanum(III) triflate in tripropylene glycol is added and the mixture is heated at 160° C. for approximately 6-8 hours. 1.2 ml of tetramethylammonium hydroxide in tripropylene glycol is added as de-activator of the catalyst after the mixture has cooled to 100° C. The temperature is kept at 80° C. for a further half hour.

Preparation of Epoxide E-5

A three-neck flask is fitted with a mechanical stirrer, a thermometer and a vacuum line. Stirring is kept through the whole reaction. A mixture of 20 g Boltorn® H30 (a dendritic polyester polyol with theoretically 32 primary hydroxyl groups per molecule and a molecular weight of approximately 3600 glmol supplied by Perstorp) and 60.4 g bisphenol A diglycidylether having an epoxide content of 5.3 val/kg is dried at 110° C. under vacuum for half an hour. 1.0 ml 5% lanthanum(III) triflate in tripropylene glycol is added and the mixture is heated at 160° C. for approximately 6-8 hours. 1.0 ml of tetramethylammonium hydroxide in tripropylene glycol is added as de-activator of the catalyst after the mixture has cooled to 100° C. The temperature is kept at 80° C. for a further half hour.

Preparation of Epoxide E-6

A three-neck flask is fitted with a mechanical stirrer, a thermometer and a vacuum line. Stirring is kept through the whole reaction. A mixture of 20 g Boltorn® H20 (a dendritic polyester polyol with theoretically 16 primary hydroxyl groups per molecule and a molecular weight of approximately 1800 g/mol supplied by Perstorp) and 62 g bisphenol A diglycidylether having an epoxide content of 5.3 val/kg is dried at 110° C. under vacuum for half an hour. 1.0 ml 5% lanthanum(III) triflate in tripropylene glycol is added and the mixture is heated at 160° C. for approximately 6-8 hours. 1.0 ml of tetramethylammonium hydroxide in tripropylene glycol is added as de-activator of the catalyst after the mixture has cooled to 100° C. The temperature is kept at 80° C. for a further half hour.

Preparation of Epoxide E-7

A three-neck flask is fitted with a mechanical stirrer, a thermometer and a vacuum line. Stirring is kept through the whole reaction. A mixture of bisphenol A diglycidylether having an epoxide content of 5.3 val/kg (66.3 g) and polypropylene glycol 770 (33.3 g) is heated 30 min at 80° C. under vacuum. A 5% solution of lanthanum(III)triflate in polytetrahydrofurane 650 (0.4 g) is added and the reaction mixture is heated at 140° C. for 5 hours by which time the epoxide content has fallen to 2.7 mol/kg. A 2% solution of tetramethylammonium hydroxide (0.4 g) is added and the reaction is allowed to cool to room temperature under vacuum with agitation.

Preparation of Amine Am-1

37.3 g 1,13-diamino-4,7,10-trioxatridecane is heated at 95° C. 62.7 g Epoxide E-7 is slowly added in batches keeping the temperature below 120° C. and cooling back to 95° C. before any further additions of Epoxide E-7. After complete addition of Epoxide E-7 the reaction mixture is heated at 95° C. for a further 3 hours.

Preparation of Amine Am-2

A mixture of Epoxide E-1 (58 g) and 1,6-diamino-2,2,4-trimethylhexane (42 g) is mixed well at room temperature to give a homogeneous solution. This mixture is then heated at 60° C. in an oven for 48 hours.

Preparation of Amine Am-3

68 g Jeffamine T403 (a polyamine of the formula E—(NH₂)₃ wherein E is a radical of formula VId and E₁ is a radical of formula VIIb) is heated at 60° C. Epoxide E-3 (50 g) is slowly added in batches keeping the temperature below 90° C. and cooling back to 60° C. before any further additions of epoxide. After complete addition of Epoxide E-3 the reaction mixture is heated at 95° C. for a further 3 hours.

Preparation of Amine Am-4

16 g 1,6-diamino-2,2,4-trimethylhexane is heated at 60° C. Epoxide E-3 (32.2 g) is slowly added in batches keeping the temperature below 90° C. and cooling back to 60° C. before any further additions of epoxide. After complete addition of Epoxide E-3 the reaction mixture is heated at 95° C. for a further 3 hours.

Preparation of Amine Am-5

105 g Jeffamine T403 (a polyamine of the formula E—(NH₂)₃ wherein E is a radical of formula VId and E₁ is a radical of formula VIIb) is heated at 60° C. Epoxide E-2 (50 g) is slowly added in batches keeping the temperature below 90° C. and cooling back to 60° C. before any further additions of epoxide. After complete addition of Epoxide E-2 the reaction mixture is heated at 95° C. for a further 3 hours.

Preparation of Amine Am-6

80 g 1,6-diamino-2,2,4-trimethylhexane is heated at 60° C. Epoxide E-4 (53.9 g) is slowly added in batches keeping the temperature below 80° C. and cooling back to 60° C. before any further additions of epoxide. After complete addition of Epoxide E-4 the reaction mixture is heated at 95° C. for a further 3 hours.

Preparation of Amine Am-7

150 g Jeffamine D230 (a polyamine of the formula E—(NH₂)₂ wherein E is a radical of formula VIc) is heated at 60° C. Epoxide E-4 (53.9 g) is slowly added in batches keeping the temperature below 80° C. and cooling back to 60° C. before any further additions of epoxide. After complete addition of Epoxide E-4 the reaction mixture is heated at 95° C. for a further 3 hours.

### Application Example 1

Amine Am-6 (55 parts by weight) and bisphenol A diglycidyl ether having an epoxide content of 5.3 val/kg (45 parts by weight) are mixed at room temperature to give a hazy solution.

This solution is applied, after addition of 0.1 mm glass beads (0.1 parts by weight), onto degreased chromic acid etched aluminium test pieces and made into a lap-shear joint of 12.5 mm overlap. This is cured in an over for 2 hours at 60° C. to give a firm bond.

1. A compound of the formula I 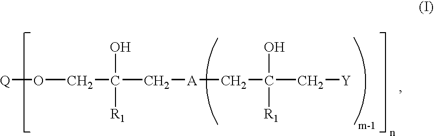
wherein Q denotes a n-valent residue of an aliphatic polyol having a weight average molecular weight m_{w} of 100 to 25000, n is an integer from 2 to 512,
R₁ is hydrogen or methyl,
A denotes a m-valent aliphatic, cycloaliphatic, aromatic or araliphatic radical, m is an integer from 2 to 4, and y is a radical of formula II or III 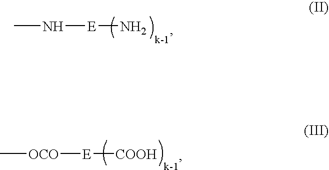
wherein E is a k-valent aliphatic, cycloaliphatc, aromatic or araliphatic radical and k is an integer from 2 to 4.

2. A compound of formula I according to claim 1 wherein Q is the bivalent residue, after removal of the hydroxyl groups, of a polyalkylene glycol, the trivalent residue, after removal of the hydroxyl groups, of trimethylolpropane, ethoxylated trimethylolpropane or propoxylated trimethylolpropane, the tetravalent residue, after removal of the hydroxyl groups, of pentaerythritol, ethoxylated pentaerythritol, propoxylated pentaeryithritol, a polyglycol obtainable by reaction of pentaerythritol with ethylene oxide, propylene oxide, tetrahydrofuran or ε-caprolactone, or Q is the hexavalent residue, after removal of the hydroxyl groups, of dipentaerythritol, ethoxylated dipentaerythritol, propoxylated dipentaerythritol, a polyglycol obtainable by reaction of dipentaerythritol with ethylene oxide, propylene oxide, tetrahydrofuran or ε-caprolactone, or Q is the residue of a hydroxyl- or carboxyl-terminated dendritic macromolecule containing a nucleus derived from a monomeric or polymeric compound having at least one reactive hydroxyl, carboxyl or epoxy group per molecule and at least one branching generation derived from a monomeric or polymeric chain extender having at least three reactive sites per molecule selected from hydroxyl and carboxyl groups.

3. A compound of formula 1 according to claim 1 wherein Q is the bivalent residue, after removal of the hydroxyl groups, of a polyethylene glycol, a polypropylene glycol or a polytetrahydrofurane or the residue of a hydroxyl-terminated dendritc macromolecule containing 8 to 256 hydroxyl groups per molecule and having a weight average molecular weight m_{w} from 500 to 25000.

4. A compound of formula I according to claim 1 wherein R₁ is hydrogen, m is 2 and A is a bivalent radical of the formula IVa to IVd 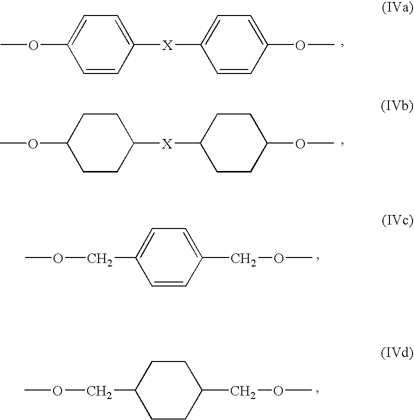
wherein X is a direct bond, methylene, isopropylidene, —CO or —SO₂—.

5. A compound of formula I according to claim 1 wherein R₁ is hydrogen, m is 3 or 4 and A is a trivalent radical of the formula Va or a tetravalent radical of formula Vb

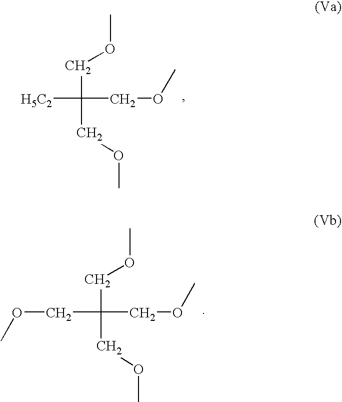

6. A compound of formula I according to claim 1 wherein Y is a radical of formula II wherein E denotes a bivalent, trivalent or tetravalent aliphatic radical containing up to 100 carbon atoms in which one or more carbon atoms may be replaced by oxygen or nitrogen atoms.

7. A compound of formula I according to claim 1 wherein Y is a radical of formula II wherein E denotes a radical of formula VIa to VIg 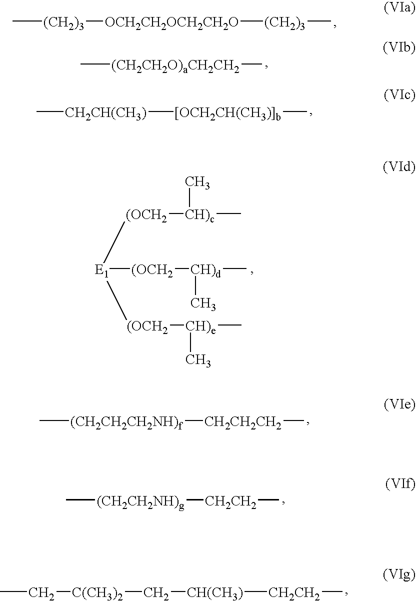
wherein a and b are an integer from 1 to 10, c, d and e independently of one another are an integer from 1 to 20, f is an integer from 1 to 5, g is an integer from 1 to 10 and E₁ is a radical of formula VIIa or VIIb

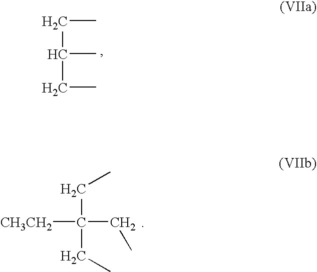

8. A compound of formula I according to claim 1 wherein Y is a radical of formula III wherein E is the bivalent residue, after removal of the carboxyl groups, of an aliphatic dicarboxylic acid containing 4 to 20 carbon atoms or of a dimer fatty acid.

9. A process for the preparation of a compound of formula I according to claim 1 which comprises reacting a compound Q—(OH)ₙ wherein Q and n are as defined in claim 1 with a compound of formula VIII 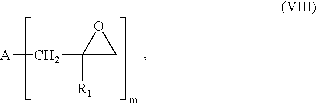
wherein A, R₁ and m are as defined in claim 1, in such amounts that 1.5 to 15.0 epoxy equivalents are present per hydroxy equivalent in the presence of a triflate salt of a metal of Group IIA, IIB, IIIA, IIIB or VIIIA of the Periodic Table of the Elements (according to the IUPAC 1970 convention), optionally deactivating the triflate salt catalyst when the desired amount of modification has been achieved, and subsequently reacting the epoxy group containing intermediate thus obtained with a polyamine of the formula E—(NH₂)ₖ or a polycarboxylic acid of the formula E—(COOH)ₖ wherein E and k are as defined in claim 1 in such amounts that at least two NH₂ groups or COOH groups are present per epoxy group of the intermediate.

10. A process according to claim 9 in which the deactivation of the triflate salt catalyst is effected by adding an alkali metal hydroxide or a metal complexing agent.

11. A process according to claim 9 in which the amount of the triflate salt catalyst ranges from 10 to 500 ppm, based on the total composition.

12. A process according to claim 9 for the preparation of a compound of formula I according to claim 1 which comprises employing the hydroxy compound Q—(OH)ₙ and the epoxy compound of formula VII in such amounts that the ratio of hydroxy groups:epoxy groups is between 1:1.5 and 1:10.

13. A process according to claim 9 for the preparation of a compound of formula I according to claim 1 characterised in that 1 to 5 mol polyamine of the formula E—(NH₂)ₖ or polycarboxylic acid of the formula E—(COOH)ₖ is employed per mol epoxy groups of the intermediate obtained by reaction of Q—(OH)ₙ with a compound of formula VIII.

14. A curable composition containing
(a) an epoxy resin and
(b) a compound of formula I according to claim 1.

15. A crosslinked product obtainable by curing a composition according to claim 14.

16. The use of a composition according to claim 14 as adhesive or casting resin.
